(19) United States
(12) Patent Application Publication
(10) Pub. No.: US 2014/0023919 A1
(43) Pub. Date: Jan. 23, 2014

(54) NON-AQUEOUS ELECTROLYTE SECONDARY CELL

(71) Applicants: Keisuke Minami, Kanzaki-gun (JP); Toyoki Fujihara, Kanzaki-gun (JP); Toshiyuki Nohma, Kobe-shi (JP)

(72) Inventors: Keisuke Minami, Kanzaki-gun (JP); Toyoki Fujihara, Kanzaki-gun (JP); Toshiyuki Nohma, Kobe-shi (JP)

(73) Assignee: SANYO ELECTRIC CO., LTD., Osaka (JP)

(21) Appl. No.: 13/550,744

(22) Filed: Jul. 17, 2012

(51) Int. Cl. H01M 4/02

(52) U.S. Cl. 429/209

(57) ABSTRACT

The present invention aims to provide the following non-aqueous electrolyte secondary cell having excellent safety. A non-aqueous electrolyte secondary cell comprises an electrode assembly having positive and negative electrodes. The positive electrode has a core exposed portion (formed by exposing at least one side edge of a belt-shaped core along the longitudinal direction of the core), a active material layer formed on the core, and a protective layer (formed on the core exposed portion near the active material layer and having a lower conductivity than the core). The negative electrode has first and second negative electrode core exposed portions, in which both side edges of a belt-shaped negative electrode core are exposed along the longitudinal direction of the core, and a negative electrode active material layer formed on the negative electrode core. And the whole of the second negative electrode core exposed portion is opposite to the protective layer.

### BACKGROUND OF THE INVENTION

1. Field of the Invention

The present invention relates to a non-aqueous electrolyte secondary cell.

2. Background Art

Recently, there have become popular cell-powered vehicles such as electric vehicles (EV) and hybrid electric vehicles (HEV), which use a secondary cell as a drive power source. The cell-powered vehicle requires a secondary cell with high output and high capacity.

A non-aqueous electrolyte secondary cell typified by a lithium ion secondary cell has high energy density and high capacity. Moreover, because of its large facing area between the positive and negative electrode plates, it is easy to draw a large current from the electrode assembly formed by winding the positive and negative electrode plates comprising active material layers provided on both surfaces of the electrode core via a separator. For this reason, the non-aqueous electrolyte secondary cell having the laminated or spirally wound electrode assembly is used in the above applications.

However, in such a cell, a large current would also flow when an internal short circuit occurs in the cell due to conductive foreign matter contamination and the like. In order to secure safety of the cell, it is required to prevent occurrence of internal short circuit and to reduce short-circuit current.

### SUMMARY OF THE INVENTION

The present invention is made in view of the above, and aims to productively provide a non-aqueous electrolyte secondary cell having excellent safety, high output and high capacity.

For the purpose of solution of the above problems, the prismatic cell according to the present invention has the following configuration.

A non-aqueous electrolyte secondary cell comprises an electrode assembly having a positive electrode plate and a negative electrode plate,

wherein:

the positive electrode plate has a positive electrode core exposed portion, which is formed by exposing at least one side edge of a belt-shaped positive electrode core along the longitudinal direction of the positive electrode core, and a positive electrode active material layer formed on the positive electrode core;

the negative electrode plate has first and second negative electrode core exposed portions, which are formed by exposing both side edges of a belt-shaped negative electrode core along the longitudinal direction of the negative electrode core, and a negative electrode active material layer formed on the negative electrode core;

a positive electrode protective layer is provided on the positive electrode core exposed portion in the vicinity of the positive electrode active material layer;

the whole of the second negative electrode core exposed portion is opposite to the positive electrode protective layer; and

the positive electrode protective layer has a lower conductivity than the positive electrode core.

Since each core of the positive and negative electrode plates has lower resistance than each active material layer, if an internal short circuit occurs in the area where the cores of the positive and negative electrode plates are opposed to each other, very large current would flow.

In the above configuration, a protective layer is each provided on the positive and negative electrode cores in the area where the positive and negative electrode cores are opposed to each other and where very large current flows during an internal short circuit. Since this protective layer has lower conductive than the positive electrode core, if a conductive foreign material is mixed in the core opposing area, it is possible to decrease the flowing current or to prevent an internal short circuit. Thereby, explosion and ignition of the cell can be prevented, thus enhancing the safety.

In the above-described configuration, an insulative negative electrode protective layer may be provided on the negative electrode active material layer.

This configuration can enhance the insulation between the positive and negative electrode active material layers because of the insulative negative electrode protective layer, and therefore the safety is improved.

Also, when the porosity of the negative electrode protective layer is larger than that of the negative electrode active material layer, it is possible to enhance non-aqueous electrolyte retention capability and permeability of the non-aqueous electrolyte into the negative electrode. Thereby, liquid injection time can be shortened, and the cell characteristics such as cycle and load characteristics are improved.

In the above configuration, the negative electrode protective layer may be also provided on the second negative electrode core exposed portion that is continuous to the negative electrode protective layer.

This configuration can further increase the insulation between positive and negative electrode cores because of the insulative negative electrode protective layer, and the safety is further improved.

In addition, the negative electrode protective layer on the second electrode core exposed portion may be partly or wholly provided on the second negative electrode core exposed portion. When the negative electrode protective layer is wholly provided, the insulation between the positive and negative electrode cores can be further enhanced.

It is also possible to adopt a configuration in which an insulative negative electrode protective layer are provided on the first negative electrode core exposed portion that is continuous to the negative electrode protective layer.

In the above configuration, the positive electrode protective layer may be continuously provided to the positive electrode active material layer.

With the configuration in which the positive electrode active material layer is continuous to the positive electrode protective layer (i.e., in which there is no gap between the positive electrode active material layer and the positive electrode protective layer), the positive electrode protective layer serves so as to enhance the permeability of the non-aqueous electrolyte into the positive electrode active material layer, and therefore the production efficiency is improved.

Preferably, the positive electrode protective layer comprises inorganic particles and a binder. As the inorganic particles, there can be used conductive inorganic particles such as graphite particles and carbon particles or insulative inorganic particles such as zirconia particles, alumina particles and titania particles. As the binder, there can be used an acrylonitrile-based binder, a fluorine-based binder or the like.

In case of that the positive electrode protective layer contains conductive inorganic particles, if any internal short-circuit occurs due to conductive foreign materials in the area where the electrode cores are opposed, then weak internal short-circuit current can continue to flow so that the cell can be brought to a safe state. On the other hand, when the positive electrode protective layer uses only insulative inorganic particles, it is possible to reliably prevent an internal short circuit in the area where the electrode cores are opposed to each other. Moreover, by mixing conductive inorganic particles and insulative inorganic particles, it is possible to control the current value to a desired value in case of an internal short circuit due to a conductive foreign material.

When a material having a large contrast compared to the positive electrode core material is used as the inorganic particle, there is an advantage that failure of the protective layer formation can be recognized by visual means. For example, when pure aluminum or aluminum alloy is used as a positive electrode core while the inorganic particles contain graphite particles, the contrast between them becomes larger.

In view of the above, the inorganic particles in the positive electrode protective layer may be appropriately selected depending on safety standards and productivity required for the cell and depending on the presence or absence of the negative electrode protective layer on the negative electrode core exposed portion, etc.

### BRIEF DESCRIPTION OF THE DRAWING

FIG. 1 is a perspective view of a cell according to Embodiment 1.

FIG. 2 is a diagram showing an electrode assembly according to Embodiment 1.

FIG. 3 is a cross-sectional view explaining a laminated state of the positive and negative electrode plates in the electrode assembly according to Embodiment 1.

FIG. 4 is a cross-sectional view explaining a laminated state of the positive and negative electrode plates in the vicinity of the positive electrode protective layer.

FIG. 5 is a diagram showing a fabrication process of the positive and negative electrode plates. FIG. 5A shows the positive electrode plate, and FIG. 5B shows the negative electrode plate.

FIG. 6 is a cross-sectional view explaining a laminated state of the positive and negative electrode plates in the electrode assembly according to Embodiment 2.

FIG. 7 is a cross-sectional view illustrating a modified example of a laminated state of the positive and negative electrode plates in the electrode assembly according to Embodiment 2.

FIG. 8 is a cross-sectional view illustrating a further modified example of a laminated state of the positive and negative electrode plates in the electrode assembly according to Embodiment 2.

### DETAILED DESCRIPTION OF THE INVENTION

### Embodiment 1

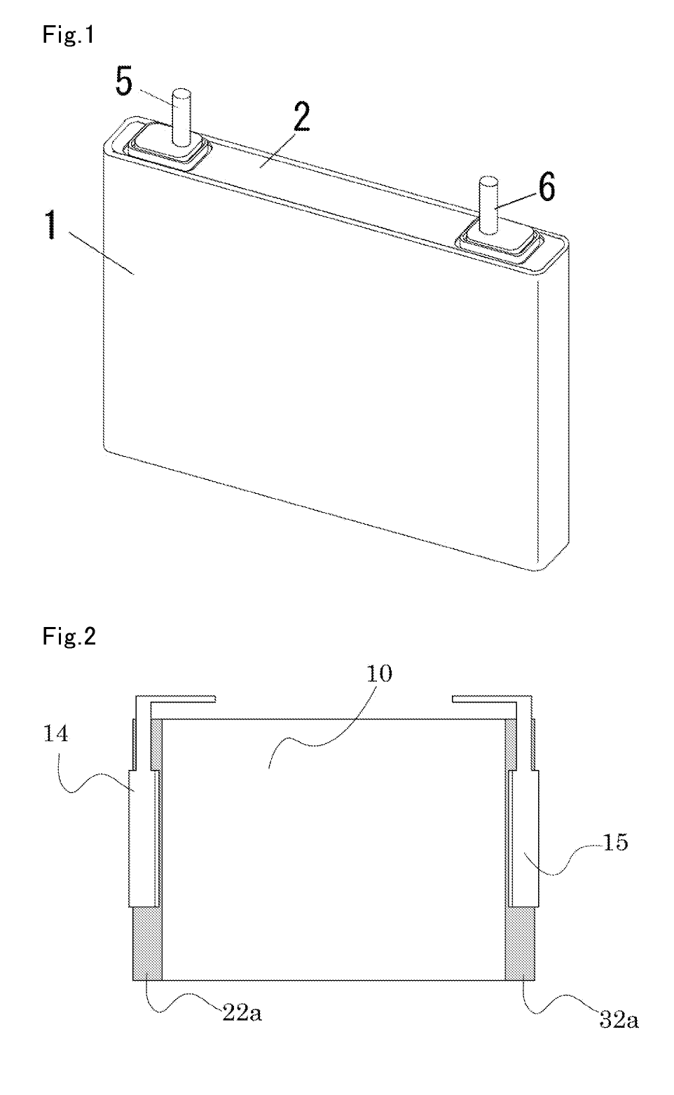

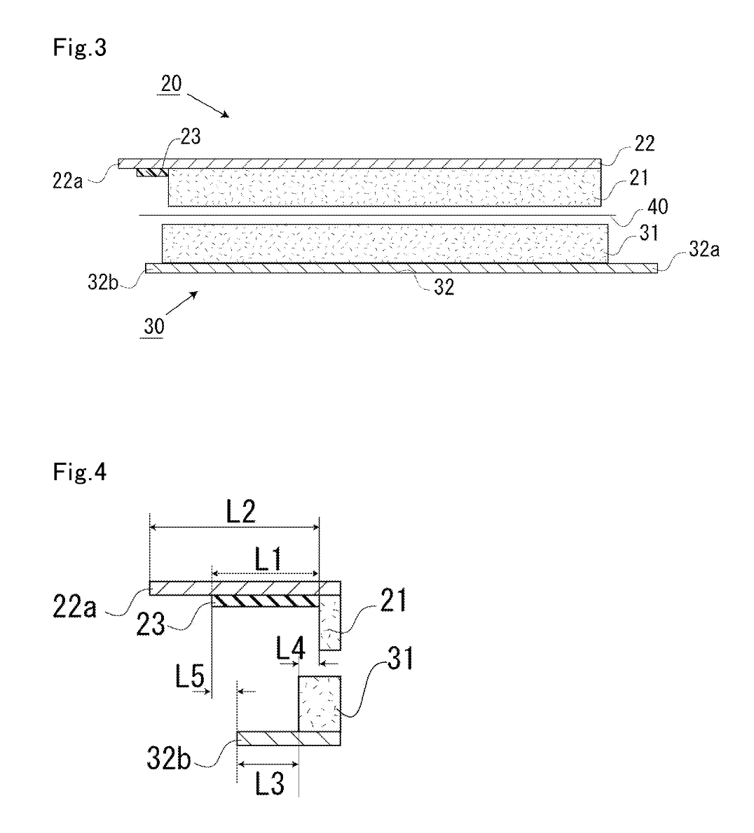

A case of applying the present invention to a lithium ion secondary cell will be described below with reference to the drawings. FIG. 1 is a perspective view of a lithium ion secondary cell according to Embodiment 1. FIG. 2 is a diagram showing the electrode assembly used in the lithium ion secondary cell. FIG. 3 is a cross-sectional view explaining a laminated state of the positive and negative electrode plates in the electrode assembly according to Embodiment 1. FIG. 4 is a cross-sectional view explaining a laminated state of the positive and negative electrode plates in the vicinity of the positive electrode protective layer.

As shown in FIG. 1, the lithium ion secondary cell according to this Embodiment has a prismatic outer can 1 having an opening, a sealing body 2 for sealing the opening of the outer can 1, and positive and negative electrode external terminals 5 and 6 projecting from the sealing body 2 to the outside.

In addition, as shown in FIG. 3, the positive electrode plate constituting the electrode assembly comprises: a positive electrode core exposed portion 22a formed by exposing at least one side edge of the belt-shaped positive electrode core 22 along the longitudinal direction of the core 22; and a positive electrode active material layer 21 formed on the positive electrode core 22. In addition, on the positive electrode core exposed portion 22a in the vicinity of the positive electrode active material layer 21, a positive electrode protection layer 23 is provided continuously to the positive electrode active material layer 21. Meanwhile, the negative electrode plate 30 comprises: first and second negative electrode core exposed portions 32a and 32b formed by exposing both side edges of the belt-shaped negative electrode core 32 along the longitudinal direction of the core 32; and a negative electrode active material layer 31 formed on the negative electrode core 32.

The electrode assembly 10 is formed by winding the positive and negative electrodes via a separator composed of a microporous membrane made of polyethylene. As shown in FIG. 2, the positive electrode core exposed portion 22a protrudes from one end of the electrode assembly 10 while the first negative electrode core exposed portion 32a protrudes from the other end of the electrode assembly 10. The positive electrode current collector plate 14 is attached to the positive electrode core exposed portion 22a while the negative electrode current collector plate 15 is attached to the first negative electrode core exposed portion 32a.

This electrode assembly 10 is housed in the above outer can together with the non-aqueous electrolyte. The positive electrode current collector plate 14 and negative electrode current collector plate 15 are electrically connected to external terminals 5 and 6 protruding and insulated from the sealing body 2, respectively. Thereby, electrical current is brought to the outside.

In addition, the positive electrode protective layer 23 is configured so that its conductivity may be lower than that of the positive electrode core 22.

As shown in FIG. 4, when the widths of the positive electrode protective layer 23 and the second negative electrode core exposed portion 32b are respectively defined as L1 and L3, their relation is L3≦L1. The end of the negative electrode active material layer 31 is located at the same position as the end of the positive electrode active material layer 21, or protrudes toward the end side of the positive electrode core exposed portion 22a more than the end of the positive electrode active material layer 21. Meanwhile, the end of the positive electrode protective layer 23 is located at the same position as the end of the second negative electrode core exposed portion 32b, or protrudes toward the end side of the positive electrode core exposed portion 22a more than the second negative electrode core exposed portion 32b. That is, the whole of the second negative electrode core exposed portion 32b is opposed to the positive electrode protective layer 23.

In the above configuration, the positive electrode protective layer 23 is provided on the positive electrode core exposed portion 22a in the area where the positive electrode core exposed portion 22a and the second negative electrode core exposed portion 32b, both of which are highly conductive, are opposed to each other. Since this protective layer has lower conductivity than the positive electrode core 22, when short circuit occurs in this area due to a conductive foreign material, it is possible to prevent a large current from flowing. Thereby, the risk of explosion or combustion of the cell can be eliminated.

If the end of the positive electrode active material layer 21 protrudes toward the end side of the positive electrode core exposed portion 22a more than the end of the negative electrode active material layer 31, a deposition of lithium occurs, due to charging and discharging, on the second negative electrode core exposed portion 32b opposed to the positive electrode active material layer 21, thus reducing the safety of the cell. Meanwhile, if the end of the second negative electrode core exposed portion 32b protrudes toward the end side of the positive electrode core exposed portion 22a more than the positive electrode protective layer 23, an internal short circuit in the core exposed portion having high conductivity cannot be reliably prevented.

Therefore, in order to prevent an internal short circuit between the core exposed portions, it is necessary to satisfy the following requirements: the width L1 of the positive electrode protective layer 23 is equal to or greater than the width L3 of the second negative electrode core exposed portion 32b; the distance L4 between the end of the positive electrode active material layer 21 and the end of the negative electrode active material layer 31 is 0 μm or more; and the distance L5 between the end of the second negative electrode core exposed portion 32b and the end of the positive electrode protective layer 23 is 0 μm or more. In a word, it is essential that the whole of the second negative electrode core exposed portion 32b be opposed to the positive electrode protective layer 23.

More preferably, L4 is 1 to 3 μm and L5 is 3 to 8 μm. In addition, when the width of the positive electrode core exposed portion 22a is defined as L2, L2 is preferably included in the range of 5 to 10 μm. In addition, the thickness of the positive electrode protective layer is preferably equal to or less than that of the positive electrode active material layer. Specifically, it is more preferably that the thickness of the positive electrode protective layer is 20 μm or more and 80% or less of the thickness of the positive electrode active material layer.

In addition, the positive electrode protective layer preferably contains inorganic particles and a binder. As inorganic particles, there can be used conductive inorganic particles such as graphite and carbon particles or insulative inorganic particles such as zirconia particles, alumina particles and titania particles. The average particle diameter of inorganic particles is preferably 0.1 to 10 μm. In addition, an acrylonitrile-based binder, a fluorine-based binder and the like can be used as the binder.

In addition, enhancing the safety is required particularly for a high-capacity cell having discharge capacity of 4 Ah or more. Therefore, it is preferable that the present invention is applied to such a cell.

There is described a method for producing the lithium ion secondary cell having the above structure.

### <Preparation of Positive Electrode Plate>

A positive electrode active material of lithium-containing nickel cobalt manganese complex oxide (LiNi_{0.35}Co_{0.35}Mn_{0.3}O₂), a carbonaceous conductive agent such as acetylene black and graphite, and a binder of polyvinylidene fluoride (PVDF) are weighed at a mass ratio of 88:9:3. Then, these are dissolved in an organic solvent such as N-methyl-2-pyrrolidone (NMP) and mixed to prepare a positive electrode active material slurry.

Then, using a die coater or doctor blade, etc., the positive electrode active material slurry is applied in a uniform thickness on both surfaces of the positive electrode core 22 composed of a belt-shaped aluminum foil (thickness 15 μm). However, the slurry is not applied on one side edge (the same side in both surfaces) of the positive electrode core 22 along the longitudinal direction, thereby forming a positive electrode core exposed portion 22a.

This electrode plate is passed through a dryer to remove the organic solvent and to prepare a dry electrode plate. This dry electrode plate is pressed using a roll press machine. Then, a positive electrode protective layer slurry is applied to the positive electrode core exposed portion 22a continuous to the positive electrode active material layer 21. The positive electrode protective layer slurry is a mixture of 53 parts by mass of alumina as insulative inorganic particles, 2 parts by mass of carbon as conductive inorganic particles and a coloring agent, 9 parts by mass of polyvinylidene fluoride (PVDF) as a binder, and 36 parts by mass of NMP as a solvent. Then, the applied plate is dried to form a positive electrode protective layer 23. Thereafter, the resulting plate is cut into a predetermined size to prepare a positive electrode plate 20.

### <Preparation of Negative Electrode Plate>

A negative electrode active material of graphite, a binder of a styrene-butadiene rubber, and a thickening agent of carboxymethylcellulose are weighed in a mass ratio of 98:1:1. Then, these are mixed with an appropriate amount of water to prepare a negative electrode active material slurry.

Then, using a die coater or doctor blade, etc., the negative electrode active material slurry is applied in a uniform thickness on both surfaces of the negative electrode core 32 composed of a belt-shaped copper foil (thickness 10 μm). However, the slurry is not applied on both side edges of the negative electrode core 32 along the longitudinal direction, thereby forming first and second negative electrode core exposed portions 32a and 32b.

This electrode plate is passed through a dryer to remove moisture to produce a dry electrode plate. Then, this dry electrode plate is pressed using a roll press machine, and then cut into a predetermined size to prepare a negative electrode plate 30.

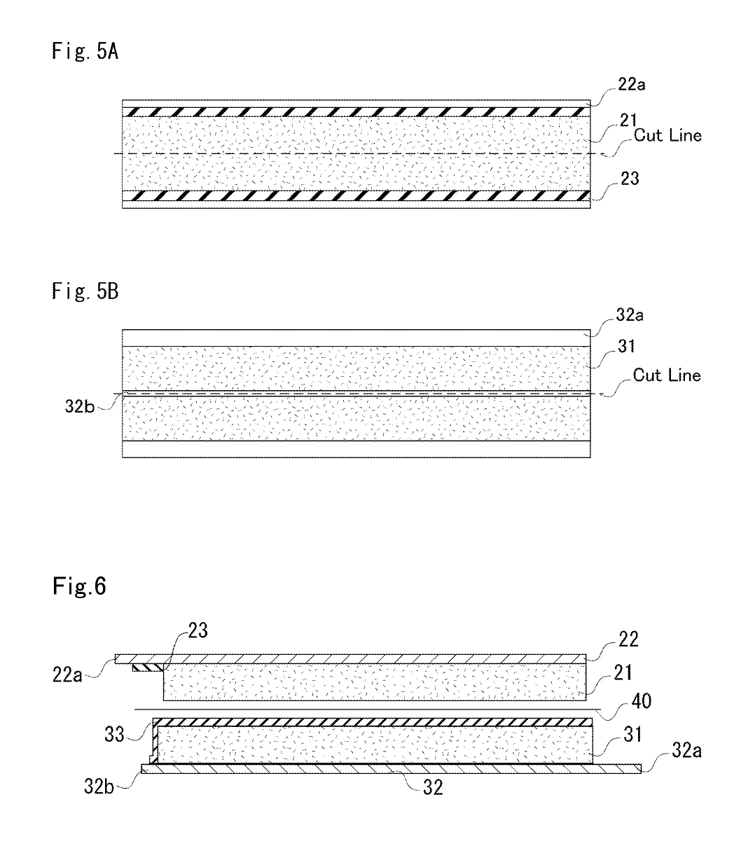

Meanwhile, from the viewpoint of improving productivity, during the production of the positive and negative electrode plates, an electrode core wider than one electrode plate is used to simultaneously form a plurality of active material layers and the like. Then, they are cut to predetermined width and length, thus to obtain a plurality of electrode plates. As shown in FIG. 5A, in the case of a positive electrode plate using a lithium-containing transition metal composite oxide as a positive electrode active material, there does not occur a problem that, for example, the active material is removed from the positive electrode active material layer 21 even when cutting on the positive electrode active material layer 21. Thus, such cutting is adopted.

On the other hand, in the case of a negative electrode plate using carbon material as a negative electrode active material, if the plate is cut on the active material layer or at the boundary between the active material layer and the core exposed portion, there is a possibility of removal of the active material from the active material layer. The removed material may be a conductive foreign material and may cause an internal short circuit between the positive and negative electrodes. For this reason, as shown in FIG. 5B, a core exposed portion 32b is provided between the negative electrode active material layers 31 and 31 to prevent a conductive foreign material, and the plate is cut on this core exposed portion. For this reason, the resulting negative electrode plate has a structure in which negative electrode core exposed portions 32a and 32b are formed on both sides of the negative electrode active material layer 31.

In addition, FIGS. 5A and 5B show examples of simultaneous fabrication of two electrode plates. However, in fact, more than two electrode plates are fabricated at the same time.

### <Preparation of Electrode Assembly>

As shown in FIG. 3, three members (a positive electrode, a negative electrode and a separator made of microporous polyethylene membrane) are positioned and overlapped so that:

the positive electrode core exposed portion 22a and the first negative electrode core exposed portion 32a protrude in directions counter to each other relative to the winding direction;

the whole of the second negative electrode core exposed portion 32b is opposed to the positive electrode protective layer 23; and

the separator is interposed between the different active material layers.

The three laminated members are wound using a winder, and an insulative winding-end tape is stuck thereon. Then, the resulting wound body is pressed to complete a flat electrode assembly.

### <Connection of Current Collector Plate to Sealing Body>

There are prepared one positive electrode current collector plate 14 made of aluminum and one negative electrode current collector plate 15 made of copper, on each of which two convex portions (not shown) are separately formed protruding to one plane side. Moreover, there are prepared two positive electrode current collector plate receiving members (not shown) made of aluminum and two negative electrode current collector plate receiving members (not shown) made of copper, on each of which one convex portion is formed protruding to one plane side. Then, an insulative tape is stuck so as to surround the convex portions of the positive electrode current collector plate 14, the negative electrode current collector plate 15, the positive electrode current collector plate receiving member and the negative electrode current collector plate receiving member.

A gasket (not shown) is arranged inside of a through hole (not shown) formed in the sealing body 2, and arranged on the outer surface of the cell surrounding the through hole. Meanwhile, an insulating member (not shown) is arranged on the inner surface of the cell surrounding the through hole formed in the sealing body 2. And the positive electrode current collector plate 14 is positioned on the insulating member provided on the cell inner surface of the sealing body 2 so as to overlap the through hole of the sealing body 2 with the through hole (not shown) provided in the current collector plate. Then, an insertion portion of the positive electrode external terminal 5 having a flange portion (not shown) the insertion portion (not shown) is passed through the through holes of the sealing body 2 and the current collector plate from the outside of the cell. While this structure is kept, the diameter of the lower part (cell inner part) of the insertion portion is increased, and the positive electrode external terminal 5 is caulked to the sealing body 2 along with the positive electrode current collector plate 14.

The same manner is also applied to the negative electrode. The negative electrode external terminal 6 is caulked to the sealing body 2 along with the negative electrode current collector plate 15. This process makes each member integrated, and further the positive and negative electrode current collector plates14 and 15 are conductively connected to the positive and negative electrode external terminals 5 and 6. And the positive and negative electrode external terminals 5 and 6 protrude from the sealing body 2 with them insulated from the sealing body 2.

### <Attachment of Current Collector Plates>

Onto one surface of the core exposed portion in the positive electrode 20 of the flat electrode assembly, the positive electrode current collector plate 14 is applied with its convex portions on the side of the positive electrode core exposed portion 22a.

Then, one of the positive electrode current collecting plate receiving members is applied onto the positive electrode core exposed portion 22a in such a manner that the convex portion thereof would come into contact with the positive electrode core exposed portion 22a and that one of the convex portions of the positive electrode current collecting plate 14 and the convex portion of the positive electrode current collecting plate receiving member would oppose to one another. Thereafter, a pair of welding electrodes are applied on the back of the convex portion of the positive electrode current collector plate 14 and the back of the convex portion of the positive electrode current collecting plate receiving member. Electric current is flowed to resistance weld the positive electrode current collector plates14 and the positive electrode current collecting plate receiving member to the positive electrode core exposed portion 22a.

Then, the other positive electrode current collecting plate receiving members is applied onto the positive electrode core exposed portion 22a in such a manner that the convex portion thereof would come into contact with the positive electrode core exposed portion 22a and that the other convex portions of the positive electrode current collecting plate 14 and the convex portion of the positive electrode current collecting plate receiving member would oppose to one another. Thereafter, a pair of welding electrodes are applied on the back of the convex portion of the positive electrode current collector plate 14 and the back of the convex portion of the positive electrode current collecting plate receiving member. Electric current is flowed to the welding electrodes for a second resistance welding. Through the above process, the positive electrode current collector plate 14 and positive electrode current collector plate receiving member are fixed to the positive electrode core exposed portion 22a.

The same manner is also applied to the negative electrode 30. The negative electrode current collector plate 15 and the negative electrode current collector plate receiving member are resistance welded to the first negative electrode core exposed portion 32a.

### <Preparation of a Non-Aqueous Electrolyte>

LiPF₆ as an electrolyte salt is dissolved at 1.0M (mol/l) into non-aqueous solvent in which ethylene carbonate (EC) and ethyl methyl carbonate (EMC) are mixed in the ratio of 3:7 (volume ratio converted at 1 atm and 25 ° C.), thus forming a base electrolyte solution.

Then, 0.3% by mass of vinylene carbonate, 0.1 M of lithium bis(oxalate)borate (LiB(C₂O₄)₂) and 0.05 M of lithium difluorophosphate LiPO₂F₂) are added to the above base electrolyte solution to form a non-aqueous electrolyte.

### <Fabrication of Cell>

The electrode assembly 10 integrated with the sealing body 2 is inserted in an outer can 1, and the opening of the outer can 1 is fitted to the sealing body 2. Then the joint of the outer can 1 and the periphery of the sealing body 2 are laser welded. After injecting a predetermined amount of the above-mentioned non-aqueous electrolyte into a non-aqueous electrolyte injection hole (not shown) provided on the sealing body 2, this non-aqueous electrolyte injection hole is sealed.

### Embodiment 2

This Embodiment will be described with reference to FIG. 6. FIG. 6 is a cross-sectional view explaining the laminated state of positive and negative electrode plates in the electrode assembly according to Embodiment 2.

This Embodiment is similar to above-mentioned Embodiment 1 except that an insulative negative electrode protective layer is provided on the surface of the negative electrode active material layer 31.

With this configuration, in addition to the effects described in the above-mentioned Embodiment 1, it is possible to further improve the insulation between the positive and negative electrode active material layers because of the insulative negative electrode protective layer, thus further improving the safety. Moreover, when the porosity of the negative electrode protective layer is larger than that of the negative electrode active material layer, the electrolyte retention capability of the negative electrode can be enhanced, liquid injection time can be shortened, and cell characteristics such as load characteristics and cycle characteristics can be improved.

The method for preparing the insulative negative electrode protective layer is explained below.

Alumina powder as insulative inorganic particles, an acrylonitrile-based binder and N-methyl-2-pyrrolidone (NMP) are mixed in a mass ratio of 30:0.9:69.1 to prepare a slurry, and this slurry is applied on the dried negative electrode after rolling and on the negative electrode active material layer. This electrode plate is dried again, and NMP required for the slurry preparation was evaporated and removed to prepare the negative electrode having the negative electrode protective layer 33.

It is preferable that the thickness of the protective layer is 1 to 10 μm, and the porosity of the protective layer is 60 to 90%. And it is preferred that the average particle diameter of the insulative inorganic particles is 0.1 to 10 μm. Moreover, the insulative inorganic particles is preferably at least one selected from the group consisting of alumina particles, titania particles and zirconia particles.

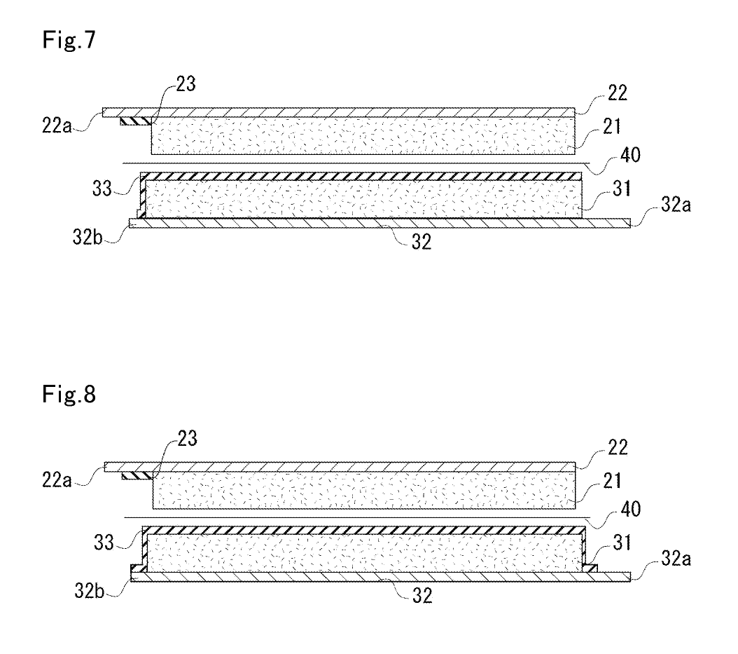

As shown in FIG. 7, the negative electrode protective layer 33 may be also provided on the second negative electrode core exposed portion 32b that is continuous to the negative electrode active material layer 31. Moreover, as shown in FIG. 8, the insulative negative electrode protective layer 33 may be wholly provided on the second negative electrode core exposed portion 32b while the layer 33 may be partly provided on the first negative electrode core exposed portion 32a that is continuous to the negative electrode active material layer 31.

In these configurations, the insulation between the positive and negative electrode cores can be further increased because of the insulative negative electrode protective layer, and safety is further improved.

Similarly to the negative electrode, an insulative positive electrode active material protective layer can be provided on the positive electrode active material layer. In this case, the positive electrode protective layer and the positive electrode active material protective layer can be integrally provided as a positive electrode protective layer.

### (Supplementary Remarks)

The positive electrode active material include, for example, lithium-containing transition metal composite oxides such as lithium-containing nickel cobalt manganese complex oxide (LiNiₓCo_{y}Mn_{z}O₂, x+y+z=1, 0≦x≦1, 0≦y≦1, 0≦z≦1), lithium manganese oxide (LiMn₂O₄), olivine-type lithium iron phosphate (LiFePO₄), and compounds obtained by substituting a part of transition metals contained in the above oxides with other elements. These compounds can be used alone or in a mixture of two or more.

As the negative electrode active material, there can be used, for example, carbonaceous materials such as natural graphite, carbon black, coke, glassy carbon, carbon fiber and calcined materials thereof. Also, there can be used a mixture of the above carbonaceous materials with at least one selected from the group consisting of lithium, lithium alloy and metal oxides capable of intercalating and deintercalating lithium.

In addition, the non-aqueous solvent can be a mixture of a low viscosity solvent and a high dielectric solvent having a high solubility of lithium salt. Examples of the high dielectric solvent include ethylene carbonate, propylene carbonate, butylene carbonate, and γ-butyrolactone. Examples of the low viscosity solvent include diethyl carbonate, dimethyl carbonate, ethyl methyl carbonate, 1,2-dimethoxyethane, tetrahydrofuran, anisole, 1,4-dioxane, 4-methyl-2-pentanone, cyclohexanone, acetonitrile, propionitrile, dimethylformamide, sulfolane, methyl formate, ethyl formate, methyl acetate, ethyl acetate, propyl acetate, and ethyl propionate. In addition, the non-aqueous solvent may be a mixture of two or more high dielectric solvents and two or more low viscosity solvents as listed above.

Examples of the electrolyte salt include LiPF₆, LiN(C₂F₅SO₂)₂, LiN(CF₃SO₂)₂, LiClO₄ and LiBF₄, all of which can be used alone or in combination of two or more. Moreover, lithium bis(oxalate)borate, lithium difluorophosphate and the like can be also added to the above lithium salts. The total concentration of lithium salt in the non-aqueous electrolyte is preferably 0.5 to 2 M(mol/l).

It is also possible to add known additives such as vinylene carbonate, cyclohexyl benzene and tert-amylbenzene to the non-aqueous electrolyte.

Although the separator is not an essential component for the present invention, when no insulative protective layer is not provided on the positive and negative electrode active material layers, the separator insulating between the positive and negative electrode plates is required. As the separator, there can be used a microporous film composed of olefin resins such as polyethylene, polypropylene and a mixture or laminate thereof.

Moreover, it is preferred that the width of the separator is equal to or more than the width of the area where the positive and negative electrode plates are opposed to each other.

As explained above, the present invention can provide a non-aqueous electrolyte secondary cell having excellent safety. Thus, the industrial applicability is significant.

What is claimed is:

1. A non-aqueous electrolyte secondary cell comprising an electrode assembly having a positive electrode plate and a negative electrode plate,
wherein:
the positive electrode plate has a positive electrode core exposed portion, which is formed by exposing at least one side edge of a belt-shaped positive electrode core along the longitudinal direction of the positive electrode core, and a positive electrode active material layer formed on the positive electrode core;
the negative electrode plate has first and second negative electrode core exposed portions, which are formed by exposing both side edges of a belt-shaped negative electrode core along the longitudinal direction of the negative electrode core, and a negative electrode active material layer formed on the negative electrode core;
a positive electrode protective layer is provided on the positive electrode core exposed portion in the vicinity of the positive electrode active material layer;
the whole of the second negative electrode core exposed portion is opposite to the positive electrode protective layer; and
the positive electrode protective layer has a lower conductivity than the positive electrode core.

2. The non-aqueous electrolyte secondary cell according to claim 1, wherein an insulative negative electrode protective layer is provided on the negative electrode active material layer.

3. The non-aqueous electrolyte secondary cell according to claim 2, wherein the negative electrode protective layer is further provided on the second negative electrode core exposed portion continuous to the negative electrode protective layer.

4. The non-aqueous electrolyte secondary cell according to claim 3, wherein the negative electrode protective layer is provided on the whole of the second negative electrode core exposed portion.

5. The non-aqueous electrolyte secondary cell according to claim 1, wherein the positive electrode protective layer is continuously provided to the positive electrode active material layer.

6. The non-aqueous electrolyte secondary cell according to claim 3, wherein the negative electrode protective layer is further provided on the first negative electrode core exposed portion continuous to the negative electrode protective layer.

7. The non-aqueous electrolyte secondary cell according to claim 1, wherein the positive electrode protective layer comprises insulative inorganic particles, conductive inorganic particles and a binder.

8. The non-aqueous electrolyte secondary cell according to claim 7, wherein the conductive inorganic particles serve as a coloring agent.

9. The non-aqueous electrolyte secondary cell according to claim 1, wherein the thickness of the positive electrode protective layer is equal to or less than the thickness of the positive electrode active material layer.

10. The non-aqueous electrolyte secondary cell according to claim 9, wherein the thickness of the positive electrode protective layer is 80% or less of the thickness of the positive electrode active material layer.

11. The non-aqueous electrolyte secondary cell according to claim 7, wherein the average particle diameter of the inorganic particles in the positive electrode protective layer is 0.1 to 10 μm.

12. The non-aqueous electrolyte secondary cell according to claim 2, wherein the negative electrode protective layer comprises insulative inorganic particles and a binder.

13. The non-aqueous electrolyte secondary cell according to claim 2, wherein the thickness of the negative electrode protective layer is 1 to 10 μm.

14. The non-aqueous electrolyte secondary cell according to claim 2, wherein the porosity of the negative electrode protective layer is 60 to 90%.

15. The non-aqueous electrolyte secondary cell according to claim 12, wherein the average particle diameter of the inorganic particles in the negative electrode protective layer is 0.1 to 10 μm.

16. The non-aqueous electrolyte secondary cell according to claim 2, wherein the porosity of the negative electrode protective layer is larger than the porosity of the negative electrode active material layer.
